(19) United States
(12) Patent Application Publication
(10) Pub. No.: US 2016/0223958 A1
(43) Pub. Date: Aug. 4, 2016

(54) IMAGE FORMING APPARATUS

(71) Applicant: CANON KABUSHIKI KAISHA, Tokyo (JP)

(72) Inventor: Taku Higashiyama, Yokohama-shi (JP)

(21) Appl. No.: 15/098,268

(22) Filed: Apr. 13, 2016

Related U.S. Application Data
(62) Division of application No. 14/638,261, filed on Mar. 4, 2015.

(30) Foreign Application Priority Data
Mar. 7, 2014 (JP) 2014-044644

(51) Int. Cl. G03G 15/20

(52) U.S. Cl. CPC G03G 15/2007

(57) ABSTRACT

An image forming apparatus includes: an image forming portion configured to form a toner image on a recording material with a first toner and a second toner which are different in color from each other; and a light irradiating portion configured to irradiate, with light, the toner image formed on the recording material by the image forming portion. The first toner and the second toner include resin materials containing a common functional group. An infrared absorption wavelength range resulting from the functional group is 2.6 μm or more and 3.6 μm or less. A maximum intensity wavelength of the light with which the toner image is irradiated by the irradiating portion is in the 2.6 μm or more and 3.6 μm or less.

### FIELD OF THE INVENTION AND RELATED ART

The present invention relates to an image forming apparatus including a fixing means for heating an image, carried on a recording material, in a non-contact manner by infrared rays. The present invention relates to the image forming apparatus including the fixing means for heating, in the non-contact manner, by infrared rays, the recording material on which the image is carried. The present invention relates to the image forming apparatus including the fixing means for heating, in the non-contact manner by infrared rays, a heating member for contact-heating the image carried on the recording material.

The image forming apparatus in which a toner image formed on an image bearing member is transferred onto the recording material and the recording material on which the toner image is transferred is heated by a fixing device as an example of the fixing means to fix the image on the recording material has been widely used. As a type of the fixing device, a contact heating type in which the toner image is heated under pressure by bringing a heated fixing roller or a heated fixing belt into contact with a toner image carrying surface of the recording material goes mainstream. Examples of the toner image may include a partly fixed image of the toner image and a fixed image of the toner image.

On the other hand, also a fixing device of a non-heating type in which a recording material surface on which a toner image is carried is irradiated with light (including infrared rays) to melt toners has been proposed (Japanese Laid-Open Patent Application (JP-A Sho 58-102247 and U.S. Pat. No. 7,141,761). In the fixing device of the non-contact heating type using visible light, light absorption factor (light absorptivity) varies depending on colors of the toner and color density, and therefore there is a problem that a fixing property (glossiness, deposition strength or the like) fluctuates between a plurality of species of the toners. Particularly, a black toner has a higher light absorptivity than a yellow toner and a transparent toner, and therefore the black toner is excessively melted when the black toner is irradiated with light having the same intensity.

In the fixing device described in JP-A Sho 58-102247, a difference in radiation energy absorptivity of the light between the toners of respective colors is alleviated by adding a common additive having an infrared absorption performance in polymeric materials for the toners of the respective colors. Further, in the fixing device described in U.S. Pat. No. 7,141,761, a surface of a heating structure is divided into a plurality of regions each where a unique three-dimensional structure such that radiation energy of a wavelength of an associated color is enhanced, so that levels of radiation energy of the wavelengths of the respective colors are uniformized in the heating member side.

However, in the fixing device described in JP-A Sho 58-102247, a cost for the additive is required. The additive tends to change a color hue and a property of the toner. In the fixing device described in U.S. Pat. No. 7,141,671, heat absorption amounts of the toner images of cyan, magenta and yellow can be uniformized, but a problem such that the black toner image absorbing all the wavelengths of the visible light is excessively melted cannot be solved.

### SUMMARY OF THE INVENTION

According to an aspect of the present invention, there is provided an image forming apparatus comprising: an image forming portion configured to form a toner image on a recording material with a first toner and a second toner which are different in color from each other; and a light irradiating portion configured to irradiate, with light, the toner image formed on the recording material by the image forming portion, wherein the first toner and the second toner include resin materials containing a common functional group, and wherein an infrared absorption wavelength range resulting from the functional group is 2.6 μm or more and 3.6 μm or less, and a maximum intensity wavelength of the light with which the toner image is irradiated by the light irradiating portion is in a range of 2.6 μm or more and 3.6 μm or less.

According to another aspect of the present invention, there is provided an image forming apparatus comprising: an image forming portion configured to form a toner image on a recording material with a yellow toner, a cyan toner, a magenta toner and a black toner which are different in color from each other; and a light irradiating portion configured to irradiate, with light, the toner image formed on the recording material by the image forming portion, wherein the yellow toner, the cyan toner, the magenta toner and the black toner include resin materials containing a common functional group, and wherein an infrared absorption wavelength range resulting from the functional group is 2.6 μm or more and 3.6 μm or less, and a maximum intensity wavelength of the light with which the toner image is irradiated by the light irradiating portion is in a range of 2.6 μm or more and 3.6 μm or less.

According to a further aspect of the present invention, there is provided an image forming apparatus comprising: an image forming apparatus comprising: an image forming portion configured to form a toner image on a recording material; a rotatable fixing member configured to fix the toner image formed on the recording material by the image forming portion; and a light irradiating portion configured to irradiate the rotatable fixing member with light, wherein the rotatable fixing member has a surface layer including a resin material containing a functional group, and wherein an infrared absorption wavelength range resulting from the functional group is 8.2 μm or more and 8.8 μm or less, and a maximum intensity wavelength of the light with which the toner image is irradiated by the light irradiating portion is in arrange of 8.2 μm or more and 8.8 μm or less.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is an illustration of a structure of an image forming apparatus.

FIG. 2 is an illustration of a structure of a fixing device in Embodiment 1.

FIG. 3 is an illustration of a lamp heater.

FIG. 4 is an illustration of an infrared absorption wavelength characteristic of each of toners.

FIG. 5 is a plan view of an uneven (projection-recess) structure of a surface of a heating element.

FIG. 6 is a sectional view of the uneven structure of the surface of the heating element with respect to a depth direction.

FIG. 7 is an illustration of a difference in infrared radiation characteristic depending on the presence or absence of a minute structure.

FIG. 8 is an illustration of a comparison in temperature rising rate between color toners.

FIG. 9 is an illustration of an infrared radiation wavelength characteristic of the heating element.

FIG. 10 is an illustration of another example including materials for the means.

In FIG. 11, (a) and (b) are illustrations of other examples of a planar shape of the uneven structure of the minute structure.

FIG. 12 is an illustration of a heating element in which the minute structure is laminated.

FIG. 13 is an illustration of a heating element in which an infrared wavelength is regulated in a gap between particles.

In FIG. 14, (a) and (b) are electron micrographs of a surface structure of a prototyped heating element.

FIG. 15 is an illustration of an infrared radiation wavelength characteristic of the prototyped heating element.

FIG. 16 is a schematic view of a fixing device provided with the prototyped heating element.

FIG. 17 is an illustration of a structure of a fixing device in Embodiment 3.

### DESCRIPTION OF THE EMBODIMENTS

Embodiments of the present invention will be described specifically with reference to the drawings.

### Embodiment 1

### Image Forming Apparatus

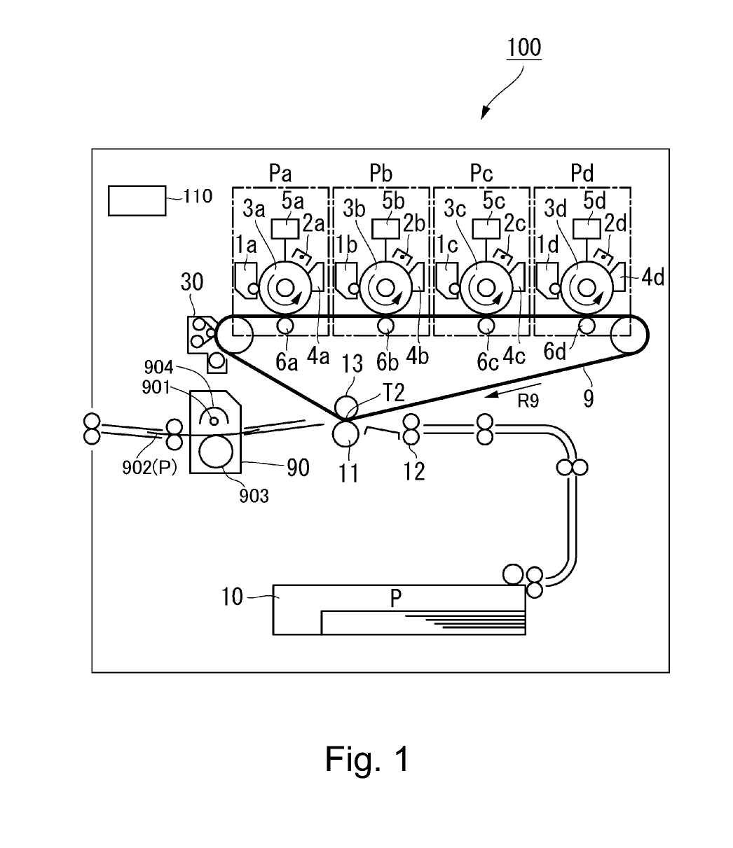

FIG. 1 is an illustration of structure of an image forming apparatus. As shown in FIG. 1, an image forming apparatus 100 in this embodiment is a tandem-type full-color printer of an intermediary transfer type in which image forming portions Pa, Pb, Pc and Pd for yellow, magenta, cyan and black, respectively, as a part of a toner image forming means are arranged along an intermediary transfer belt 9 as a part of the toner image forming means.

The image forming apparatus 100 operates the image forming portions, Pa, Pb, Pc and Pd on the basis of a color-separation image signal inputted from an external host device connected communicatably with the image forming apparatus 100, and forms and outputs a full-color image on a recording material. The external host device is a computer, an image reader or the like.

In the image forming portion Pa, a yellow toner image is formed on a photosensitive drum 3a and then is primary-transferred onto the intermediary transfer belt 9. In the image forming portion Pb, a magenta toner image is formed on a photosensitive drum 3b and is primary-transferred onto the intermediary transfer belt 9. In the image forming portions Pc and Pd, a cyan toner image and a black toner image are formed on photosensitive drums 3c and 3d, respectively, and are primary-transferred successively onto the intermediary transfer belt 9.

A recording material P is taken out from a recording material cassette 10 one by one by and is in stand-by between registration rollers 12. The recording material P is fed by the registration rollers 12 to a secondary transfer portion T2 while being timed to the toner images on the intermediary transfer belt 9. The recording material P on which the toner images are secondary-transferred from the intermediary transfer belt 9 is fed to a fixing device 90. The recording material P is, after being heated and pressed by the fixing device 90 to fix the toner images thereon, discharged to an outside of the image forming apparatus.

The image forming portions Pa, Pb, Pc and Pd have the substantially same constitution except that the colors of toners of yellow, magenta, cyan and black used in developing devices 1a, 1b, 1c and 1d are different from each other. In the following description, the image forming portion Pa will be described and other image forming portions Pb, Pc and Pd will be omitted from redundant description.

### (Image Forming Portion)

The image forming portion Pa includes the photosensitive drum 3a around which a corona charger 2a, an exposure device 5a, the developing device 1a, a primary transfer roller 6a, and a drum cleaning device 4a are provided. The photosensitive drum 3a is prepared by forming a photosensitive layer on the surface of an aluminum cylinder. The corona charger 2a electrically charges the surface of the photosensitive drum 3a to a uniform potential. The exposure device 5a writes (forms) an electrostatic image for an image on the photosensitive drum 3a by scanning with a laser beam. The developing device 1a develops the electrostatic image to form the toner image on the photosensitive drum 3a. The primary transfer roller 6a is supplied with a voltage, so that the toner image on the photosensitive drum 3a is primary-transferred onto the intermediary transfer belt 9.

A secondary transfer roller 11 contacts the intermediary transfer belt 9 supported by an opposite roller 13 to form a secondary transfer portion T2.

The drum cleaning device 4a rubs the photosensitive drum 3a with a cleaning blade to collect a transfer residual toner deposited on the photosensitive drum 3a without being transferred onto the intermediary transfer belt 9. A belt cleaning device 30 collects a transfer residual toner deposited on the intermediary transfer belt 9 without being transferred onto the recording material P at the secondary transfer portion T2.

### (Fixing Device)

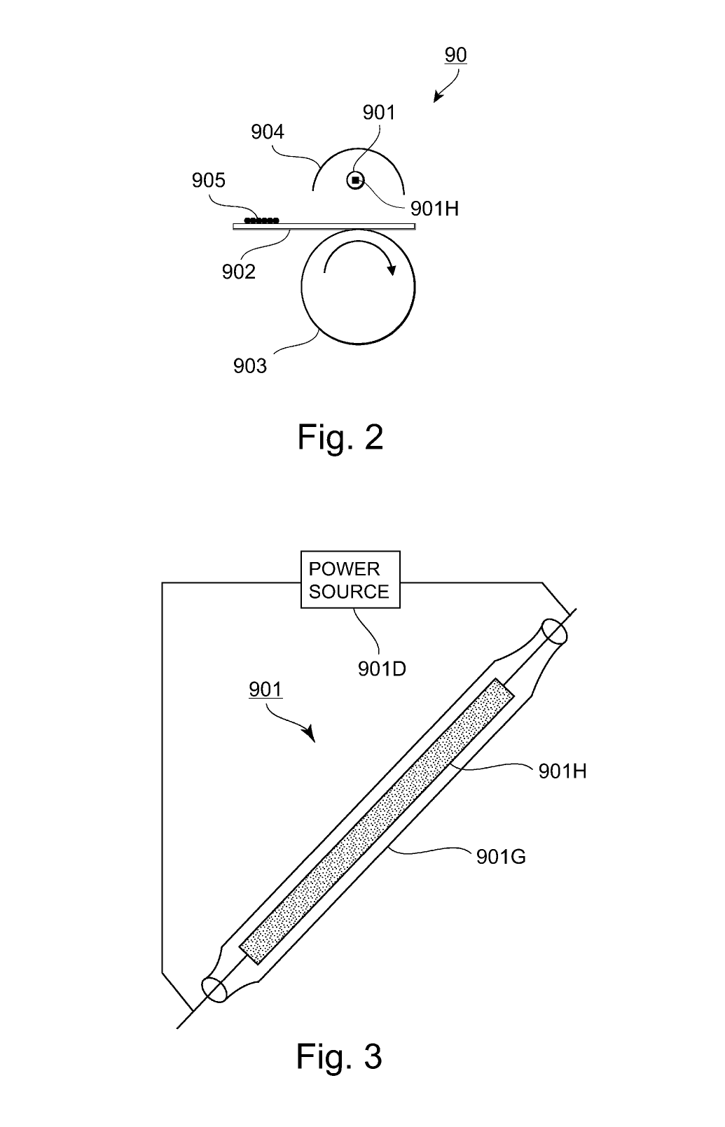

FIG. 2 is an illustration of a structure of the fixing device in this embodiment. FIG. 3 is an illustration of a structure of a lamp heater. As shown in FIG. 2, in the fixing device 90, infrared rays outputted from a lamp heater 901 are reflected by a reflecting mirror 904, so that a toner image 905 on a recording material 902 fed by a feeding roller 903 is heated. A heating portion of the develop 90 is constituted by the lamp heater 901 as a heat source and the reflecting mirror 904 as a reflecting plate.

As shown in FIG. 3, the lamp heater 901 includes a heating element 901H as a recording material source of the infrared rays. The heating element 901H is formed in a thin sheet shape by using a high-melting point metal in order to not only enhance a resistance value but also increase an infrared area of a predetermined wavelength range, and a current is passed through the heating element 901H in a longitudinal direction to generate heat to increase a temperature of the toner image. Examples of the high-melting point metal may include carbon, tungsten, nickel and titanium. Other than the high-melting point metal, it is also possible to use a metal nitride such as aluminum nitride or tantalum nitride, or a metal carbide, or the like. At a surface of an energization heating layer as an example of a light-emitting source for emitting light for heating the toner image, as described later, a periodic uneven lattice structure (minute structure) is formed for providing a wavelength selecting property of emitted infrared rays.

The heating element 901H is hermetically sealed in a transparent tube 901G of a glass material having transparency to the infrared rays. Inside the transparent tube 901G, a vacuum state is created in order to prevent oxidation of the heating element 901H. In the transparent tube 901G, inert gas having a low chemical activity such as rare gas (e.g., argon (Ar)) or nitrogen gas may also be filled. At the inert gas, the low-activity gas such as the rare gas (e.g., Ar) or nitrogen gas may desirably be used.

As a material for the transparent tube 901G, a material having the transparency to the infrared rays depending on a member-to-be-heated is selected. The transparent material which is used for the transparent tube 901G and which has the high transparency to the infrared rays is selected depending on an object-to-be-heated. Quartz glass has transparency to the infrared rays of 0.7 μm-4.0 μm in wavelength (λ), and therefore can be used for heating the toner image or paper as the member-to-be-heated having an infrared absorption peak in a wavelength range of 0.7 μm-4.0 μm.

The infrared absorption peak wavelength common to the respective color toners as the member-to-be-heated is 3.4 μm, and therefore the material of the transparent tube 901G may also be the quartz glass. However, in order to realize high-speed heat melting of the toner by increasing radiation energy reaching the toner, a material having more efficient transparency to far infrared rays than the quartz glass may suitably be used. Examples of the material having more efficient transparency to for infrared rays than the quartz glass may include a fluorinated compound of calcium, barium or the like, a zinc compound of sapphire, silicon, germanium, selenium or sulfur, and the like. When these materials are used, a transmitted light quantity of the infrared rays may preferably be increased.

In a side opposite from the recording material 902, the reflecting mirror 904 is disposed so as to cover the lamp heater 901. The reflecting mirror 904 not only black the infrared rays emitted from the lamp heater 901 toward a space opposite from the recording material 902 but also reflects the infrared rays toward the recording material 902. The reflecting mirror 904 is an elliptical reflecting mirror provided around the lamp heater 901 as a focus, and therefore also has an effect of focusing the infrared rays which are reflected toward the recording material 902. The lamp heater 901 may also be disposed near the recording material 902 as the member-to-be-heated.

The reflecting mirror 904 has an advantage that it is possible to use the metal having a high heat-resistance property. As the material for the reflecting mirror 904, a material having a higher reflectance with respect to the infrared rays may preferably be used. Specifically, noble metal such as gold or silver is excellent in reflection efficiency of the infrared rays. Further, aluminum is easy to polish and process in the case where the reflecting mirror 904 is contaminated, and therefore is used in some cases. The reflecting mirror 904 may also be constituted so that a reflectance in a particular wavelength range is increased by forming a multi-layer structure at the surface thereof.

An infrared lens may also be provided between the lamp heater 901 and the recording material 902 so as to focus the infrared rays. In the case of focusing the infrared rays by the infrared lens, there is a need to take some measure since a lens temperature increases when the infrared lens absorbs the infrared rays. For example, as a material for the infrared lens, it is desirable that a material having a high-efficiency transparency to the infrared rays is employed. In the case of focusing the infrared rays by the infrared lens, reflection of the infrared rays in an absorption wavelength range of the lens by forming a reflection-preventing film on the lens surface is also effective. In this case, it is essential to subject, to reflection-preventing coating, a lens having a high reflectance with respect to air, such as germanium or silicon.

In the fixing device 90 of the non-contact heating type, the toner and a heating structure of the fixing device 90 are in non-contact with each other, and therefore even when the toner image is fixed at a high speed, scattering of a line image does not generate, so that the toner image can be fixed even on a curved recording material or a recording material having a surface unevenness or creases. Heating is concentrated at a surface layer, and therefore a recording material having large heat absorption and a recording material having small heat absorption can be fixed at the same speed.

As the fixing device of the non-contact heating type, a flash fixing device or an infrared lamp fixing device in which the toner image is irradiated with light ranging from a visible light range to a far-infrared range has been proposed. However, in general, heat absorption varies depending on the color toner used, so that a manner of melting of the toner also changes. With respect to the black toner having high heat absorptivity, the black toner is liable to excessively melted, so that a difference in glossiness between a fixed image of the black toner and a fixed image of another color toner generates. Further, in some cases, a blister phenomenon such that the excessively melted toner generates air bubbles in a blister shape becomes problematic occurs.

Therefore, in this embodiment, these problems are solved by selecting a wavelength range of the infrared rays so that CH bond as a functional group contained common to the respective color toners. For this reason, on the surface of a generating portion of the infrared rays, a number of recessed portions closely disposed with an opening length of 1.3 μm or more and 1.8 μm or less depending on an infrared absorption peak wavelength of the CH bond (group) and OH bond (group. The recessed portions are repetitively formed at a spatial frequency contained in a range of infrared frequency (0.3 THz to 400 THz).

### (Relationship Between Functional Group and Absorption Wavelength)

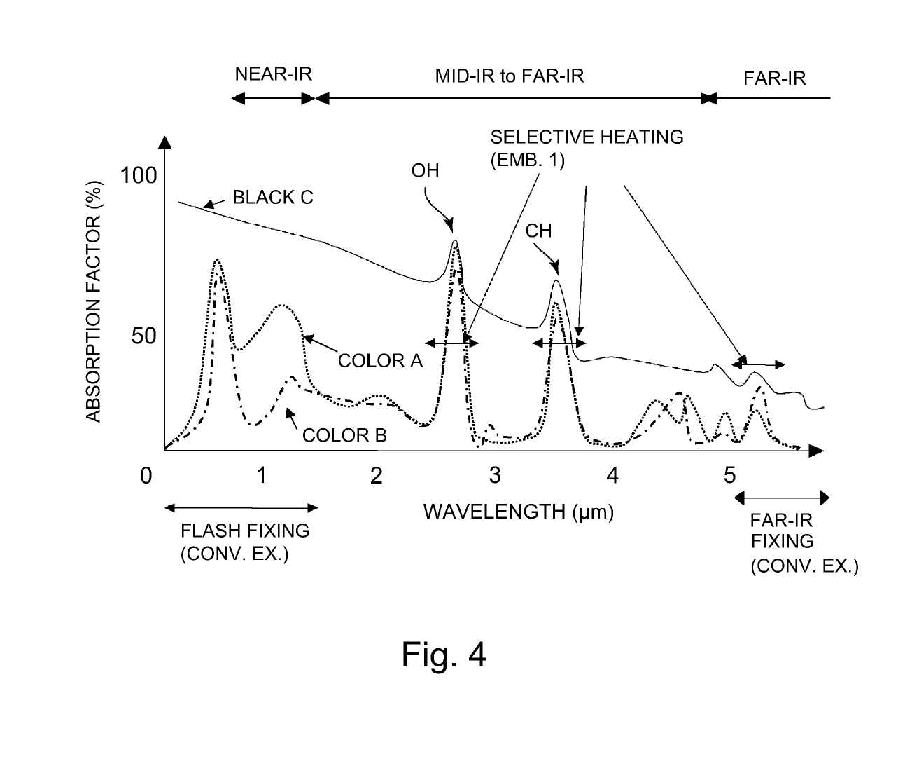

FIG. 4 is an illustration of an infrared absorption wavelength characteristic of the respective color toners. An infrared absorption characteristic of each of color toners A and B and a black toner C was measured and compared. Each of the color toners A and B and the black toner C is principally formed of a polyester resin material. The functional group is a “partial structure obtained by connecting atoms by covalent bond” defined by setting an arbitrary boundary in molecule. In FIG. 4, the abscissa represents a wavelength of the infrared rays, and the ordinate represents light absorption factor.

As shown in FIG. 4, infrared absorption wavelength ranges of the resin materials for the color toners A and B and the black toner C range from 1 μm to 7 μm while having a plurality of common absorption peaks resulting from the functional groups. As the absorption peaks resulting from the functional groups, there are absorption peaks resulting from OH group (representative absorption wavelength: 2.8 μm), NB belt (representative absorption wavelength: 3.0 μm), CH bond (representative absorption wavelength: 3.4 μm), CF bond (representative absorption wavelength: 8.3 μm and 8.7 μm) and the like in an increasing order of wavelength. It would be considered that such an infrared absorption characteristic is formed by the following mechanism.

(1) In a near-infrared range (wavelength: 760 nm-1.5 μm), the infrared absorption generates by a combination of a planar structure, a species of bond and a functional group of a polymer (polymeric material).

(2) In an intermediary range (wavelength: 1.5 μm-5.0 μm) between the near-infrared range and an infrared range, the infrared absorption generates by the functional group of the polymer. The infrared absorption characteristic is dominated by the species of the functional group contained in the polymer irrespective of the species of the polymer.

(3) In the far-infrared range (wavelength: 5.0 μm or more), the infrared absorption generated by a combination of functional groups of the polymer. The infrared absorption characteristic in this range varies depending on the species of the polymer, and is more peculiar to molecule as the molecule is more usable to identify the polymer.

In the conventional flash fixing device in which the toner image is heated by infrared irradiation, infrared rays having high energy density in a range from visible light range to the near-infrared range were used. When the infrared rays in the near-infrared range are emitted, if no measure is taken, the color toners A and B having a smaller amount of infrared absorption than the black toner C is liable to cause improper fixing since temperature rise becomes insufficient.

On the other hand, in the fixing device described in JP-A Sho 58-102247, in order to compensate for a difference in infrared absorption factor (infrared absorptivity) from the black toner C, an absorbent for the infrared rays in the near-infrared range is added in the color toners A and B. However, such an additive has a molecular structure close to a molecular structure of a pigment for the associated toner, and therefore in the case where degradation generates by absorbing the light, there is a liability that the additive changes a color hue of the toner.

Further, a conventional general-purpose ceramic heater generates the infrared rays in the far-infrared range. Also in the case of the far-infrared range, as shown in FIG. 4, compared with the black toner C, the color toners A and B have the low infrared absorption factors, and therefore a large difference in fixing property generates between the black image and the color image. When the infrared radiation peak wavelength is set at 3.4 μm only be a temperature with the use of the ceramic heater, a surface temperature of the heater is calculated as 560° C. from Wien's displacement low. When the heater surface temperature is 560° C., radiation energy density is insufficient, and therefore long-time heating is needed, so that such a heater surface temperature cannot be used for the fixing device requiring productivity. When the insufficient heating energy density is supplemented by an opposing area between the heater and the recording material, a problem such that the fixing device is upsized newly generates.

Further, also in the case where the heater surface temperature is further high, in the general-purpose ceramic heater, an energy distribution in wavelength spectrum in the infrared range of radiation light is broadened, and therefore only a unit molecular structure contained in the toner to be heated cannot be selectively heated.

Therefore, in this embodiment (Embodiment 1), an uneven portion having a minute structure is formed at the surface of the heating element, and the toner image is heated by the infrared rays in the mid-range (wavelength: 1.5 μm-5.0 μm). Particularly, the infrared rays having the wavelength of 3.2 μm-3.6 μm in which the infrared rays are efficiently absorbed and are capable of directly heating a principal component of the resin material may preferably be used since even when constituent molecules such as a color development component and a binder resin which are contained in the toner are different, the infrared radiation energy is substantially equally absorbed. As shown in FIG. 4, when the infrared rays have the wavelength of 3.3 μm-3.6 μm, the color toners A and B absorb the infrared rays with the substantially same absorption factor as that of the black toner C, and thus are heated with the substantially same heat quantity, so that heating temperatures are uniformized.

From Plank's law, the energy density is higher with light having a shorter wavelength. Therefore, also in the case where light energy is given to the functional group to be heated, it is possible to give the energy in a large amount in a shorter time with the shorter wavelength. Also from this viewpoint, the absorption band of 3.4 μm of the methylene group in the short wavelength side in the infrared range is suitable since the radiation energy from the heating element 901H is strong compared with the conventional ceramic heater or the like.

### (Structure of Heating Element)

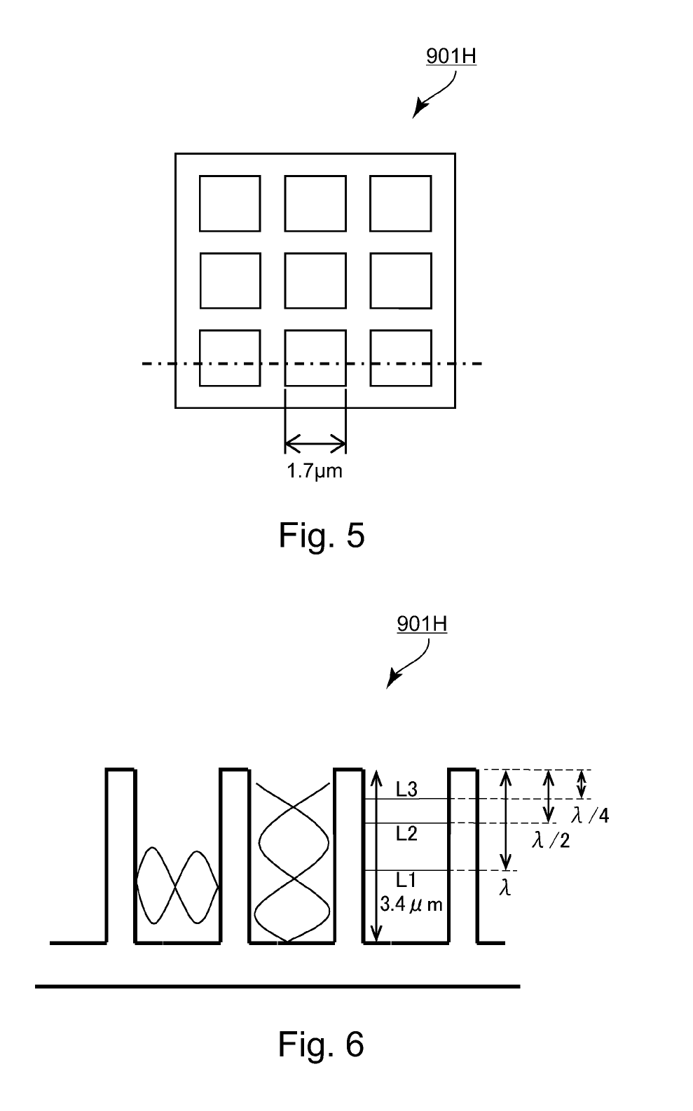

FIG. 5 is a plan view of a surface uneven structure of the heating element. FIG. 6 is a sectional view of the surface uneven structure of the heating element with respect to a depth direction. As shown in FIG. 2, the heating element 901H is a filament which has a heating layer, constituting an infrared radiation surface by heating, on four side surfaces along a longitudinal direction and which generates heat by energization. The heating element 901H irradiates the toner image on the recording material with the infrared rays having the wavelength which coincides with the infrared absorption wavelength peak resulting from the associated unit molecular structure in order to selectively heat the associated unit molecular structure contained in the resin material for the toner which is carried on the recording material and which is an object to be heated.

On the surface of the heating element 901H, a minute uneven structure, in which projected portions and recessed portions are closely provided, for imparting wavelength selectivity of the infrared rays is formed. This minute uneven structure is formed in a particular dimension L, so that a particular wavelength can be selectively oscillated and amplified.

A method of defining the dimension L will be described. As shown in FIG. 6, three points are selected with respect to a depth direction, and portions having a maximum diameter are taken as L1, L2 and L3. In FIG. 6, L1, L2 and L3 are in positions corresponding to one time, ½ time and ¼ time, respectively, the wavelength (λ). In this case, the dimension L is an average of the three points. A standard deviation σ is set at 3σ=0.1 μm in consideration that contraction and vibration of the CH bond have latitude as described later.

Further, as shown in FIG. 3, a number of recessed portions are formed on the heater surface. For example, 3.3×10⁸ recessed portions are formed in a heater area of 10 mm×10 mm. As a confirming method of a shape of these recessed portions, a method in which about 200 recessed portions are randomly selected and representative lengths thereof are measured by a SEM or the like, and then an average and the standard deviation of the measured representative lengths are calculated may only be required to be used. Further, the recessed portion shape may also be estimated from several tens of data by using t-test or the like.

As shown in FIG. 5, the heating element 901H is formed of a high-melting point metal such as nickel. On the surface of the heating element 901H, as an uneven shape, rectangular recessed portions are formed in a grid pattern. In FIG. 5, as a representative shape, a 3×3 uneven shape is shown, but in actuality, an entirety of the infrared radiation surface of the heating element 901H is occupied by an uneven-shaped three-dimensional structure in which a large number of recessed portions and recessed portions are closely disposed. This structure is repetitively formed.

As shown in FIGS. 5 and 6, a width of each rectangular recessed portion is 1.7 μm, a wall thickness between adjacent recessed portions is 0.1 μm, and a depth of each rectangular recessed portion is 3.4 μm. The representative length L=1.7 μm of the uneven portion of the minute structure is independently of the color hue of the toner, and is set at λ/2 where λ is the absorption band of 3.2 μm-3.6 μm of the methylene group (CH bond) contained in common to the resin materials as a base material for toner particles. The absorption band of the CH bond is basically 3.4 μm in contraction asymmetrical motion and 3.5 μm in contraction symmetrical motion, but in consideration of an ambient molecular structure and its declination motion, is determined in view of an absorption range of about ±0.1-0.2 μm from a center value.

As shown in FIG. 4, the resin material containing the CH bond assumes an absorption peak stronger than that in other wavelength ranges. In order to effect the radiation in the absorption range of the CH bond, the representative length L of an inside dimension of the uneven portion of the minute structure may preferably be 1.6 μm-1.8 μm. That is, an inside dimension of a unit structure of a periodical uneven lattice (grid) structure of a light-emitting source at a position of wavelength showing a maximum intensity of light with which the CH bond is irradiated may preferably be 1.6 μm or more and 1.8 μm or less.

### (Infrared Radiation Characteristic of Heating Element)

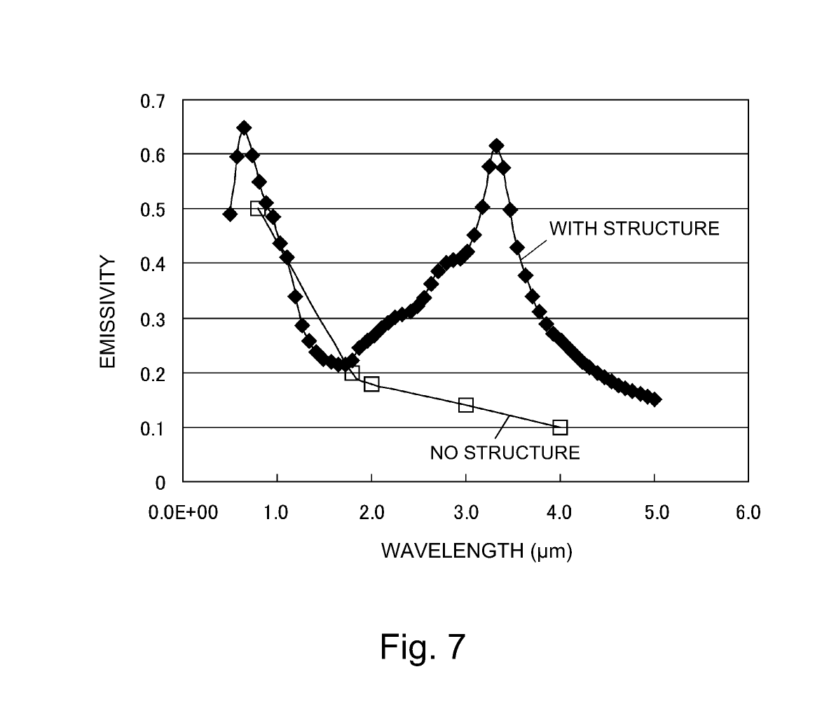

FIG. 7 is an illustration of a difference in infrared radiation characteristic depending on the presence or absence of the minute structure. The difference in infrared radiation characteristic depending on the presence or absence of the minute structure in the case where the heating element 901H is formed of nickel was obtained by a computer simulation. As shown in FIG. 7, compared with a heating element in Comparison Example in which the minute structure is not formed, the heating element 901H in this embodiment in which the minute structure is formed shows a large absorption peak in the mid-wavelength range. The heating element in Comparison Example shows an infrared radiation characteristic of an ordinary planar heating element of nickel.

In this case, a wavelength spectrum of emissivity is calculated by developing Maxwell's equations using plane wave. Optophysical values (refractive index, extinction coefficient) of nickel used for calculation are based on those described in D. W. Lynch and W. R. Hunter, “Handbook of Optical Constants of Solids I”, ed. E. D. Palik (Academic Press, New York, 1985). A boundary condition of the calculation is a periodical boundary condition, and therefore a result of the calculation is an example in which many projections and recesses exist on a flat plane (surface). From the calculation result, a reflectance and transmittance are obtained, and therefore an absorption factor (absorptivity) is obtained from a relationship of “Absorptivity=(1−Transmittance−Reflectance)”. In the case were an isotropic property is taken into consideration based on Kirchhoff's law, the emissivity is equal to the absorptivity. In this embodiment, the emissivity was shown on the premise that the Kirchhoff's law is approximately satisfied.

As shown in FIG. 7, in Embodiment 1 in which the uneven portion of the minute structure having a particularly dimension is formed on the heating element 901H, compared with Comparison Example in which the planar heating element is used, the large peak generates in a particular wavelength range. When the representative length L of the uneven portion of the minute structure is taken as a half wavelength, the emissivity is strongest (largest) in a wavelength band range which is two times the representative length L corresponding to one wavelength. The peak in the short wavelength side (portion of 1.0 μm or less) largely depends on the bond of metal lattice as is shown in also Comparison Example in which the planar heating element of nickel is used.

This is because a wavelength band (waveband) which is permitted to exist on the flat plane (surface) of the heating element 901H is limited by the representative length L of the uneven portion of the minute structure, and therefore a particular wavelength resonating as shown in FIG. 6 is strongly radiated. A standing wave generating in the recessed portions is capable of existing periodically in the form of a half wavelength, one wavelength, 1.5 wavelengths, . . . , and therefore a radiation light wavelength capable of being periodically amplified correspondingly exists. In actuality, as shown in FIGS. 5 and 6, a plurality of modes of electromagnetic wave (radiation) capable of existing with respect to a three-dimensional direction including directions of a length (width), a depth and a height exist, and of these waves, a wavelength having a highest existence probability is strongly radiated. A result of computation obtained by subjecting the mode having the highest existence probability to electromagnetic wave planar expansion (development) calculation is shown in FIG. 7.

The thickness of the wall for partitioning the recessed portions is 0.1 μm, but it would be considered that the wall thickness may preferably be thin with respect to the peak radiation intensity. However, when the wall is made thin, a mechanical strength thereof is weakened, and therefore when durability is taken into consideration, the wall thickness may preferably be thick. Practicality of the radiation intensity of the infrared rays having the wavelength of 3.4 μm was calculated by the above-described calculation method while changing the wall thickness from 0.1 μm to 1.0 μm. As a result, until the wall thickness of 1.0 μm, the radiation intensity of the infrared rays having the wavelength of 3.4 μm is enhanced by the uneven portion of the minute structure, and was evaluated as being practical. Accordingly, it is desirable that the wall thickness is 1.0 μm or less.

Further, the depth of each recessed portion may preferably be deep in a condition in which when the half wavelength is taken as a unit, the depth is an integral multiple of the unit. This is because the existence probability of the standing wave of the infrared rays having the wavelength of 3.4 μm is increased. With respect to the opening width L of each recessed portion, when the depth is about two times the uneven (half wavelength), the radiation intensity which is several times of the radiation intensity in the case where the uneven portion is not formed generates.

However, in the case where an increase in area of the heating element is taken into consideration, from the viewpoint of a manufacturing cost, the heating element may preferably be prepared using photolithography. In the case of a general photolithographic process, processing advances from the surface in the depth direction, and therefore when a ratio of the depth to the opening width is about 2, the shape can be prepared with highest accuracy. For that reason, in this embodiment, the calculation was made in a condition of 1.7 μm in width of each recessed portion and 3.4 μm in depth of each recessed portion.

As described above, in the heating element 901H in Embodiment 1, compared with the planar heating element in Comparison Example, by forming the uneven portion of the minute structure on the surface thereof, the particular wavelength depending on the representative length L of the uneven shape is radiated in a stronger manner. In this embodiment, the heating element 901H uses the infrared absorption of the CH bond which is a representative functional group of the molecules of the resin material constituting the toner.

### (Heating Based on CH Bond)

With respect to the polyester resin as an ordinary toner constituent component, it was confirmed by calculation that a sufficient temperature rise for fixing can be obtained by energy absorption resulting from the CH bond. The polyester resin used for the toner has various species. In this embodiment, of the various species of the polyester resin, as a representative example, a polyester resin having polyethylene terephthalate (C₉H₁₀O₄, molecular weight: 182) as a basic skeleton was used for the calculation. The polyethylene terephthalate has a structure represented by the following chemical formula having two CH bonds.

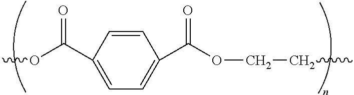

In general, a maximum amount per unit area of the toner on the recording material is about 0.6 mg/cm². Therefore, in the case where the toner image is transferred in the maximum amount per unit area onto an entire surface of an A4-sized recording material, a total amount of the toner image is 0.8 g. Assuming that 5% of the toner having the total amount of 0.8 g is the polyethylene terephthalate, on the entire surface of the A4-sized recording material, N particles of the polyethylene terephthalate (PET) exist as shown in the following equation [I].

N=(toner total amount)×(percentage of PET in total toner amount)/(molecular weight of PET)×(Avogadoro's number)×(number of CH bonds in PET)=(0.8 g×5.0%)/(182)×(6.02×10²³)×(2)=2.6×10²¹ particles [I]

Further, in the case where the toner is placed in the amount of 0.8 g in the entire region of the A4-sized recording material, energy Q required for increasing the toner temperature from a room temperature of 2.5° C. by ΔT (° C.) as an average temperature is, when a specific heat of an ordinary toner is 1.5 (J/K/g), represented by the following equation.

Q=mCΔT=0.8×1.5=1.2ΔT (J)

Accordingly, energy Q/N required to be absorbed per (one) particle of the PET is represented by the following equation [II].

Q/N=1.2ΔT/2.6×10²¹=4.6ΔT×10²² (J/particle) [II]

On the other hand, energy E per (one) photon at the representative wavelength λ=3.4 μm in the infrared absorption range of the CH bond is represented from the Planck's law by the following equation [III].

E=hC/λ=6.6×10⁻³⁴×3×10⁸/(3.4×10⁻⁶)=5.8×10⁻²⁰ (J/particle) [III]

Assuming that the CH bond absorbs 100% of the wavelength of 3.4 μm, [II]=[III] holds, and therefore the temperature rise ΔT is obtained by the following equation.

ΔT=5.8×10⁻²⁰/(4.6×10⁻²²)=126° C.

In general, in order to complete the fixing of the toner (toner image) on the recording material, as an interfacial temperature between the toner and the recording material, the temperature rise of about 130° C.-150° C. is needed, but when the interfacial temperature is converted into an average temperature of the entirety of the toner, the temperature rise may only be required to be 60° C.-90° C. For this reason, the toner can be sufficiently fixed only by the absorption by the CH bond.

In the case of the ordinary resin material used for the toner, a peak intensity difference is about ±10%. Accordingly, even when different resin materials are used for the toner of a plurality of colors, no difference in degree of melting generates.

Further, it becomes possible to obtain a necessary minimum number of the CH bonds in the toner resin material. From the above equation [III], the energy E per photon at the wavelength λ=3.4 μm is obtained from the Planck's law by the following equation.

E=hC/λ=6.6×10⁻³⁴×3×10⁸/(3.4×10⁻⁶)=5.8×10⁻²⁰ (J/particle)

When absorbance ABS of the representative PET resin (thickness: 1.0 μm) at the wavelength of 3.4 μm is measured, the following equation is obtained.

ABS=1.6

As described in a reference book (Shigenao

Maruyama, “Light Energy Engineering”, Yokendo Co., Ltd., 2004, p. 225), the absorbance ABS at the wavelength λ=3.4 μm can be converted into light absorptivity a at the wavelength λ=3.4 μm by using Lambert-Beer's law.

α=1−1/eps(ABS)=0.8 [IV]

Therefore, 80% of energy per photon is absorbed by the CH bond.

On the other hand, as described above with respect to the equation [I], a total toner amount m on the A4-sized recording material is 0.8 g, and the specific heat c of the toner is about 1.5 J/g/K, and therefore the energy Q required to increase the temperature of the toner having the total amount m by ΔT=60° C. is represented by the following equation.

Q=mcΔT=0.8×1.5×60=72 (J)

Further, 80% of the energy per photon is absorbed by the CH bond, and therefore the number N of the CH bonds required to increase the temperature of the toner having the total amount m by ΔT=60° C. is represented by the following equation.

NCH₂=72/(5.8×10⁻²⁰×0.8)=1.55×10²¹ (particles)=2.6×10⁻³ (mol)

Accordingly, it is preferable that the bond or functional group which shows the absorption peak at the wavelength of 3.4 μm in the infrared range is contained in an amount of 2.6×10⁻³ (mol) or more in the toner. Further, the number NDET of the PET (unit molecular weight: 182 g/mol), represented by the above-described chemical formula, contained in the total toner amount m=0.8 g is represented by the following equation.

NPET=0.8/182=4.4×10⁻³ (mol)

Two CH bonds are contained in the unit molecule of the PET, and therefore the number NCH of the CH bonds contained in the number NPET is represented by the following equation.

NCH=8.8×10⁻³ (mol)

Therefore, in the case of the PET resin represented by the above-described chemical formula, when the CH bond is contained in an amount of about 30%, the toner temperature can be increased by 60° C. as shown by the following formula.

NCH₂/NPET=2.6×10⁻³/8.8×10⁻³=0.3

Further, in the case where the entire resin is constituted to have the absorption band of 3.4 μm, the resin corresponds to a straight-paraffin. In that case, the molecular weight of CH₂ is 14, and therefore the following formulas are obtained.

0.8/14=57.1×10⁻³ (mol)

2.6/57.1=0.045

Accordingly, when the recording material contains the CH bond in an amount of about 4.5%, an average temperature of the toner is sufficiently increased by the heating of the CH bond.

### (Temperature Rising Rate of Toner Image)

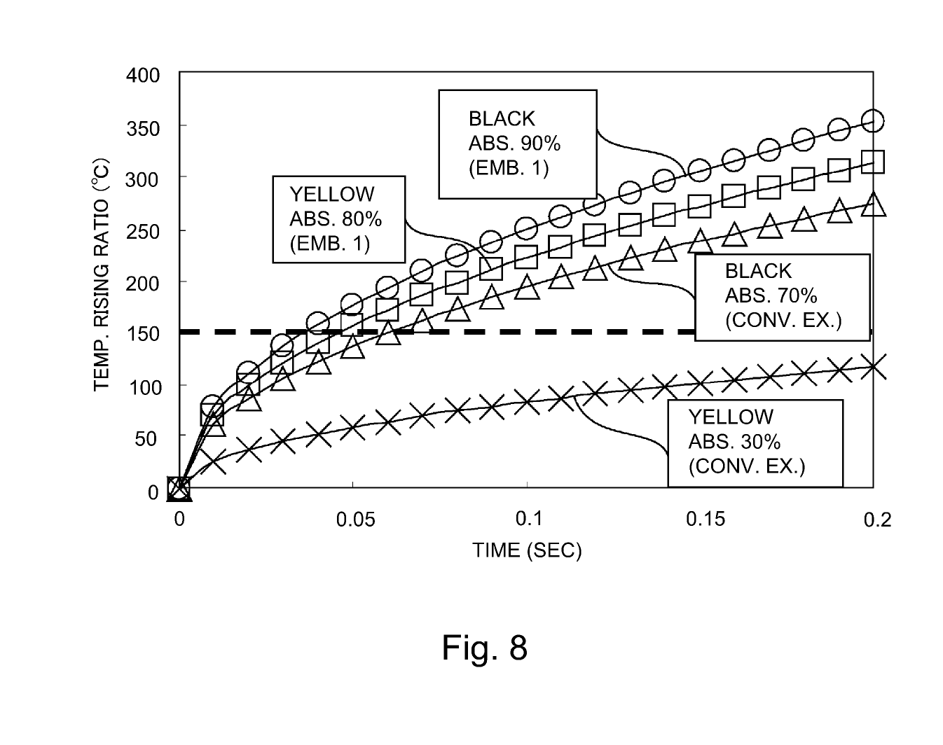

FIG. 8 is an illustration of a temperature rising rate of each of color toners. As shown in FIG. 2, the recording material on which the toner image is transferred is required that the toner temperature is increased to a threshold or more in a limited time in which the recording material passes through the fixing device 90. For that reason, the infrared rays from the heating element 901H was controlled in a short wavelength range in which the infrared rays were easily absorbed by the color toners in common, and an increase in toner temperature in a short time was calculated by one-dimensional non-steady heat conduction calculation.

As shown in FIG. 8, in a process in which the recording material passes through the heating element 901H, with a lapse of time, the temperature of the toner image on the recording material is gradually increased. In FIG. 8, the abscissa is a heating time, and the ordinate is a toner temperature rising ratio.

In a fixing process of an ordinary toner image, a largest heat quantity is needed when the toner image having a largest toner amount per unit area is melted and fixed as a whole surface image, and when the toner image is constituted by ordinary toner particles, the fixing of the toner image on the recording material is completed when the interfacial temperature between the recording material and the toner particles reaches 140° C. to 150° C. For this reason, the fixing property was evaluated by calculating one-dimensional heat absorption and radiation with respect to a toner depth direction by the one-dimensional non-steady heat conduction calculation.

The calculation was made using the black toner having a highest absorption factor in the infrared range and the yellow toner having a lowest absorption factor in the infrared range. From a result of measurement, the infrared absorption factor in the neighborhood of the wavelength of 3.2 μm-3.6 μm was taken as 90% for the black toner and 80% for the yellow toner, and average absorption factors in the infrared range (wavelength: 1 μm or more and 10 μm or less) of the black toner and the yellow toner were taken as 80% and 30%, respectively.

In the case where the toners are heated using the general-purpose heater such as the halogen lamp or the ceramic heater, a broad radiation light distribution is shown in the infrared range, and therefore the degree of heating is largely affected by a difference between the absorption factor of 70% of the black toner and the absorption factor of 30% of the yellow toner. As shown in FIG. 8, in Conventional Example, the toner temperature of the yellow toner cannot be increased insufficiently in the short time, so that a large difference in manner (degree) of melting is generated between the yellow toner and the black toner which is increased in temperature sufficiently in the same time, and thus improper fixing of an output image generates.

On the other hand, in the case where the heating element 901H is provided with the uneven portion of the minute structure, 80% or more of the energy emitted from the heating element 901H is radiated and absorbed in a common wavelength range of the black toner and the yellow toner. For this reason, the temperature difference falls within 10° C. with an error of 1.0 msec or less in time accuracy, so that a difference in degree of melting between the black toner and the yellow toner is substantially eliminated.

That is, by setting the radiation wavelength of the heating element 901H in the common wavelength range, including 3.4 μm as a center, of the black toner and the yellow toner, a difference in temperature rising time between the black toner and the yellow toner sufficiently approaches zero. For this reason, it is possible to obtain a fixed image in the same time and in a short time with less difference in color and glossiness.

### (Infrared Radiation Wavelength Characteristic of Heating Element)

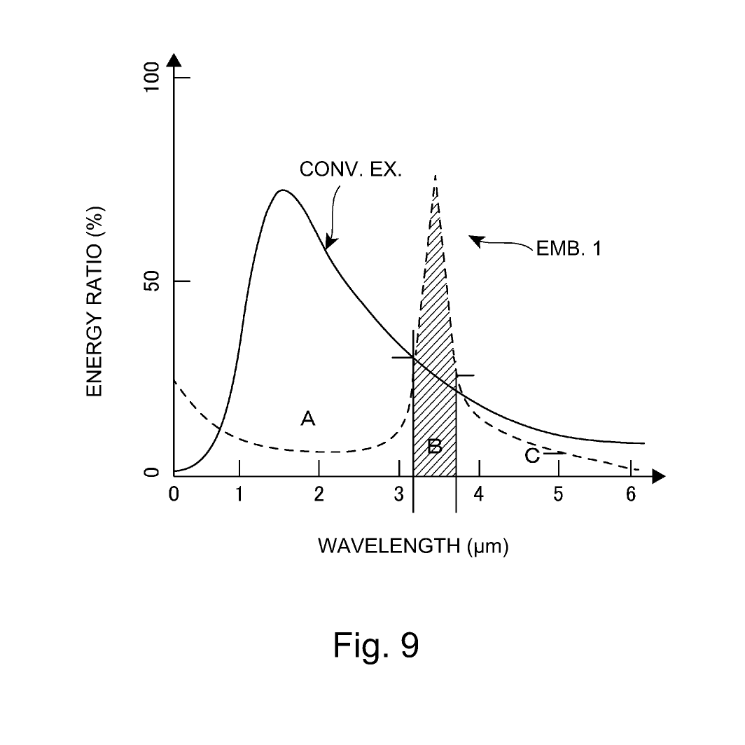

FIG. 9 is an illustration of an infrared radiation wavelength characteristic of the heating element. In FIG. 9, the ordinate is a radiation energy ratio which is an intensity ratio of radiation energy of the heating element to radiation energy of a black body, and the abscissa is wavelength of magnetic wave emitted from the heating element.

As shown in FIG. 9, in the heating element in this embodiment in which the uneven portion of the minute structure is formed, by the above-described surface structure, the intensity peak of the radiation infrared rays is set at the wavelength of 3.4 μm. On the other hand, the halogen lamp in Conventional Example used as the general-purpose heating lamp has the intensity peak of the radiation infrared rays at the wavelength of 1.8 μm, so that the radiation infrared rays having the intensity peak wavelength of 3.4 μm has a relatively narrow wavelength characteristic.

The infrared absorption peak wavelength resulting from the CH bond common to the recording material materials constituting the toner is taken as 3.2 μm to 3.6 μm, and energy ratio is divided into the following three energy ratios A, B and C.

(1) Energy ratio at wavelength of less than 3.2 μm: A

(2) Energy ratio at wavelength of 3.2 μm or more and 3.6 μm or less: B

(3) Energy ratio at wavelength of more than 3.6 μm: C

In the case of a full-color fixing device, A largest difference in light energy absorption factor generates between the black toner and the yellow toner. However, with respect to the infrared rays having the wavelength of 3.2 μm or more and 3.6 μm or less in which the infrared rays are absorbed by the CH bond, there is substantially no light energy absorption factor difference between the black toner and the yellow toner. For that reason, the radiation characteristic from the heating element is better with a higher value of “(2) Energy ratio at wavelength of 3.2 μm or more and 3.6 μm or less: B”.

On the other hand, in the case of “(1) Energy ratio at wavelength of less than 3.2 μm: A” and “(3) Energy ratio at wavelength of more than 3.6 μm: B”, a difference in degree of melting due to a difference in color between the toners is liable to generate, and therefore the radiation characteristic is better with a larger value thereof. A threshold between the ratios A, B and C in order not to cause a problem of the difference in melting state (degree) between the black toner and the yellow toner can be obtained from FIG. 8 in the following manner.

As shown in FIG. 8, at the energy absorption factor of 30% of the toner, the toner temperature does not reach an ordinary toner fixing temperature even when the toner is heated for a long time. That is, when (A+C)<30% is satisfied, this condition is a threshold for preventing excessive melting of the black toner. On the other hand, when the energy absorption factor of the toner is 70% or more, the temperatures of both of the black toner and the yellow toner reach the ordinary toner fixing temperature in a short time. Therefore, B<70% is a threshold for causing the black toner and the yellow toner to equivalently melt.

These two conditions are, in the case of the full-color fixing in which the black toner and the yellow toner are simultaneously heated, required to be simultaneously satisfied in the fixing process. Therefore, the following condition (1) holds.

(A+C)/B<30/70=3/7 (1)

From the above, effectiveness was able to be confirmed by the calculation in addition to the above-described experiment for the fixing property evaluation.

As described above, in this embodiment the toner image which is formed with the toner containing the polymer material having the CH bond and which is carried on the recording material is heated by being irradiated with the infrared rays. The surface layer of the heating element 901H as an example of the generating portion for generating the infrared rays generates the infrared rays for heating the toner image by being heated. A central portion of the heating element 901H as an example of the heating portion generates heat by energization, and heats the surface layer of the heating element 901H.

The condition (1) is also applicable to an existence ratio of the recessed portions. This is because all of the electromagnetic wave generated from the recessed portions each having the representative length L is absorbed by the toner and therefore when the recessed portions having the representative length L exists in the amount of 70% or more, the difference in manner of melting of the toner caused by the difference in color is not generated. In other words, 70% or more of the large number of minute structures may only be required to fall within the range of the representative length L.

### Effect of Embodiment 1

In Embodiment 1, on the surface of the heating element 901H, the large number of recessed portions which are closely disposed with the opening length corresponding to ½ of the wavelength of the infrared absorption peak of the CH bond are formed. By forming the predetermined minute structure on the surface of the heating element 901H, the infrared absorption wavelength peak generated by the heating element 901H is set at 3.2 μm or more and 3.6 μm or less. Each of the recessed portions of the heating element 901H has the unit structure having a depth corresponding to the integral multiple of the infrared absorption peak wavelength of the CH bond.

In other words, in this embodiment, the infrared absorption resulting from the functional group of the molecules constituting the toner and the recording material is used. By using the infrared rays in the wavelength range resonating with intrinsic lattice vibration of the polymer as the toner material, not only the temperature of the toner but also the temperature of the recording material are increased simultaneously. The CH bond contained in the respective toners, the recording material 902 and a feeding belt in common is heated.

For this reason, without particularly adding the additive or the like to the respective color toners, it is possible to selectively radiate, from the heater, the absorption wavelength of the functional group contained in the color toners in common, so that the toner image can be fixed without being influenced by the difference in color of the toners. In this way, non-uniformity of the fixing property due to the difference in color of the toners can be eliminated without adding the particular additive to the toners.

Further, the infrared rays emitted from the heating element 901H have already been focused into the particular wavelength range, and therefore the toner can be fixed in an energy saving manner compared with a constitution in which only light having a particular wavelength is transmitted through an optical filter. Compared with a constitution in which wavelength selection is made using a combination of optical filters provided on a heating element 901H which is formed of the same material in the same shape and from which only the surface uneven portion is omitted, inputted energy can be effectively radiated to realize energy saving. The heating source is operated at a lower temperature, so that the radiation in a desired wavelength range can be realized, and therefore it becomes possible to achieve energy saving and high-speed fixing.

In this embodiment, the heating element 901H is the filament, for generating heat by the energization, having the surface on which the large number of recessed portions disposed closely are formed. For this reason, compared with the case where the heating portion provided independently of the generating portion for generating the infrared rays is disposed, heat generation of the heating portion can be usefully utilized.

In this embodiment, the filament is formed in a long sheet shape extending in a direction perpendicular to a feeding direction of the recording material. For this reason, a resistance of the filament increases, and thus an amount of a current passing through the filament can be made small, so that a degree of the heat generation in an outside current supplying circuit can be alleviated.

In this embodiment, from the Planck's law, the energy density is higher with the light having a shorter wavelength. Therefore, when the light energy is given to the functional group to be heated, it is possible to give the energy in a large amount in a shorter time with the shorter wavelength.

### Modified Embodiment 1

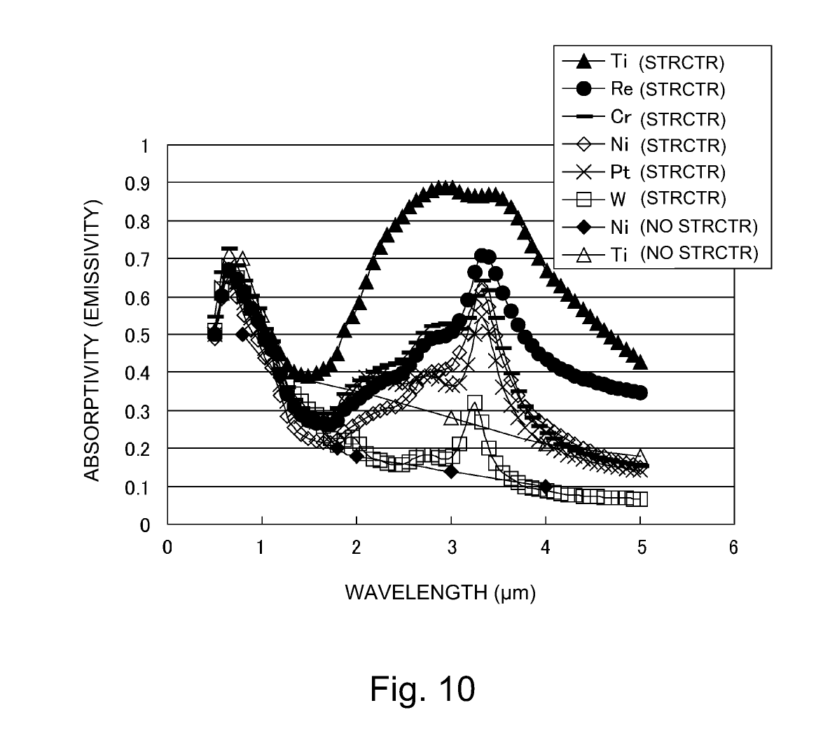

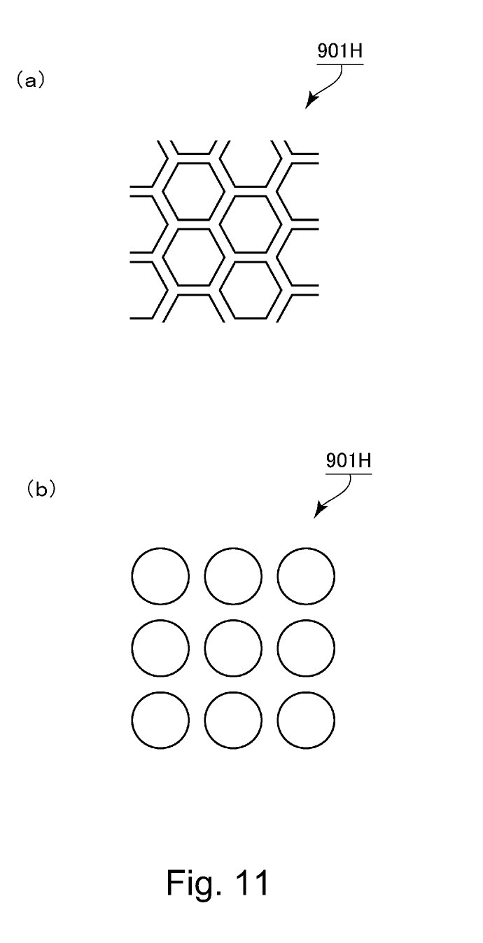

FIG. 10 is an illustration of another example of the material for the heating element. The metal material suitable for the heating element is not limited to nickel. The metal material used for the heating element may preferably have a higher melting point since metal material having the higher melting point can be made higher in temperature as the material for the heating source. Example of the metal material having the high melting point (° C.) may include tungsten (3410° C.), rhenium (3180° C.), osmium (3045° C.), tantalum (2996° C.), molybdenum (2610° C.), niobium (2468° C.), iridium (2454° C.), ruthenium (2250° C.), hafnium (2222° C.), technetium (2130° C.), rhodium (1960° C.) and titanium (1668° C.).

As shown in FIG. 10, with respect to various metal materials, in a state in which the surface minute structure is formed similarly as in the case of nickel shown in FIG. 7, the infrared absorption characteristic of each of the various metal materials was calculated by the above-described calculation method for nickel. As the calculation condition, as described above, the uneven portion opening width of 1.7 μm, the wall thickness of 0.1 μm and the uneven portion depth of 3.4 μm were set. As described above, the boundary condition of the calculation is the periodical boundary condition, and therefore as the calculation result, the case where a limitless number of uneven portions exists is assumed.

As shown in FIG. 10, of the high-melting point metal materials, titanium (Ti), rhenium (Re), chromium (Cr), nickel (Ni) and platinum (Pt) can efficiently form (generate) the infrared radiation peak in the neighborhood of the infrared absorption peak wavelength of 3.4 μm of the CH bond (group). It would be considered that as a method of processing the uneven portion of the minute structure of each of these materials, etching is desirable. For example, high-speed atomic-beam etching may desirably be employed since the high-melting point metal material can be processed in the order of several microns.

### Modified Embodiment 2

In FIG. 11, (a) and (b) are illustrations each showing another example of a planar shape of the uneven portion of the minute structure. In FIG. 11, (a) shows the planar shape having hexagonal holes (each having a representative length in a diagonal line direction, and (b) shows the planar shape having circular holes (each having a diameter as a representative length). In FIGS. 5 and 6, the three-dimensional structure in which the rectangular recessed portions are disposed in the rid shape. However, the surface minute structure of the heating element 901H shown in FIG. 3 may also be replaced with the minute structures having the uneven portions formed in a cylindrical shape and other polygonal prism shapes as shown in (a) and (b) of FIG. 11.

### Modified Embodiment 3

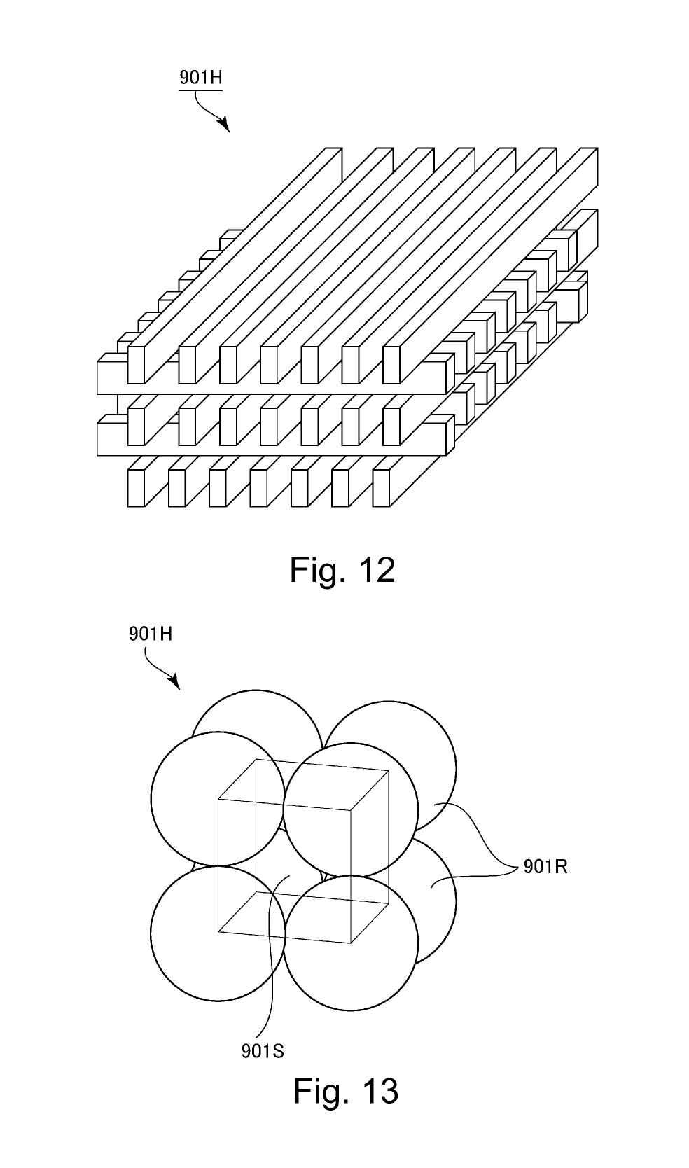

FIG. 12 is an illustration of a heating element in which minute structures are laminated. As described above, the uneven portion of the minute structure has a depth which is the integral multiple of the representative length L=1.7 μm thereof, and in order to reduce a degree of the infrared radiation of an unnecessary wavelength, it would be considered that the depth of the recessed portion is better when the depth is deeper. However, in place of an increase in depth of the recessed portion, as shown in FIG. 12, the recessed portions are laminated and disposed three-dimensionally, so that it is possible to enhance the existence probability of the steady wave of the infrared rays having the wavelength of 3.4 μm compared with the case of the single layer of the minute structure.

The above lamination structure can also be formed by repeating an operation in which a layer of the high-melting point metal material in which the recessed portions extend two-dimensionally is laminated in plural layers, and the plural layers are bonded to each other. It is also possible to three-dimensionally form the recessed portions by repeating photolithographic process and etching process. It is further possible to form the recessed portions by melting the high-melting point metal particles through laser irradiation with the use of a three-dimensional printer.

As described above, in Modified Embodiment 3, the recessed portions (grooves) of the heating element 901H has the unit structure having the depth corresponding to the integral multiple of the wavelength of the infrared absorption peak of the CH bond, and a plurality of unit structures are disposed superposedly with respect to the depth direction.

### Modified Embodiment 4

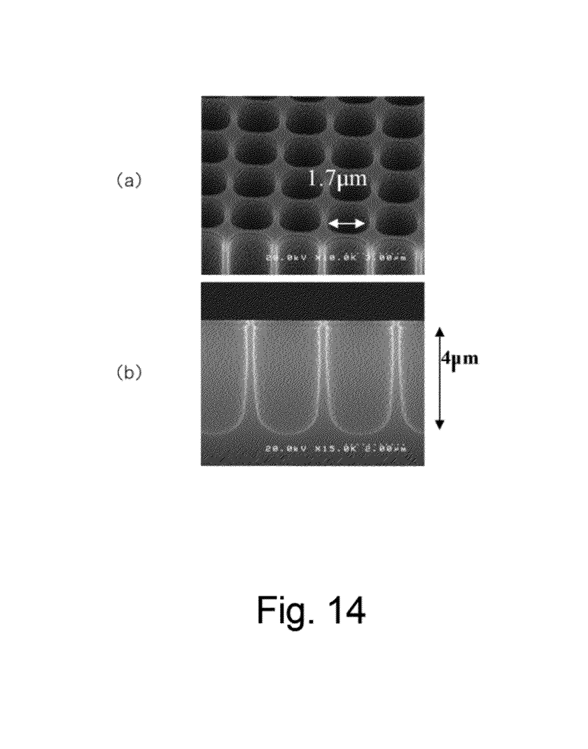

FIG. 13 is an illustration of a heating element for limiting (regulating) the infrared wavelength by a gap belt particles of the high-melting point metal. As shown in FIG. 13, spherical particles of the high-melting point metal are integrated and disposed three-dimensionally as in a simple cubic (system) structure, so that it is possible to prepare an amplifier for the infrared rays having the wavelength of 3.4 μm by using a space defined by the spherical particles.

### Modified Embodiment 5

As the method of preparing the uneven portion of the minute structure shown in FIGS. 5 and 6, a nano-imprint method is also effective. In the nano-imprint method, a structure in which projected portions as a mold for recessed portions are formed of the resin material or a silicone, and then a metal layer is formed on the surface of the structure by electroless plating with nickel. Thereafter, the resin material or the silicone is dissolved and removed, and thus a three-dimensional structure in which the recessed portions are arranged is prepared. In this case, the metal material used for the plating is limited, but such a metal material is suitable for preparing a large-sized heating element.

Further, as the method of preparing the uneven portion of the minute structure shown in FIGS. 4 and 5, it is also possible to employ laser machining and another machining (such as cutting or drilling). Particularly, machining using a femtosecond laser is capable of instantaneously prepare a minute sub-micron pattern even when tungsten as the high-melting point metal material is used, and therefore the heating element is formed in the filament for the heating source, and then the surface of the filament can be directly processed.

### Modified Embodiment 6

In general, as the resin material used for the toner, an optimum material is used in consideration of an image forming process, other than the fixing process, such as a developing process or a transfer process of the toner image, and robustness thereof after the fixing, and the like property.

Accordingly, in the present invention, the base material for the toner is not limited to the polyester resin material. It is also possible to use polyethylene resin, acrylic resin, styrene-acrylic resin as the base material when the resin material used contains the CH bond as the functional group used in the toner in general.

### Embodiment 2

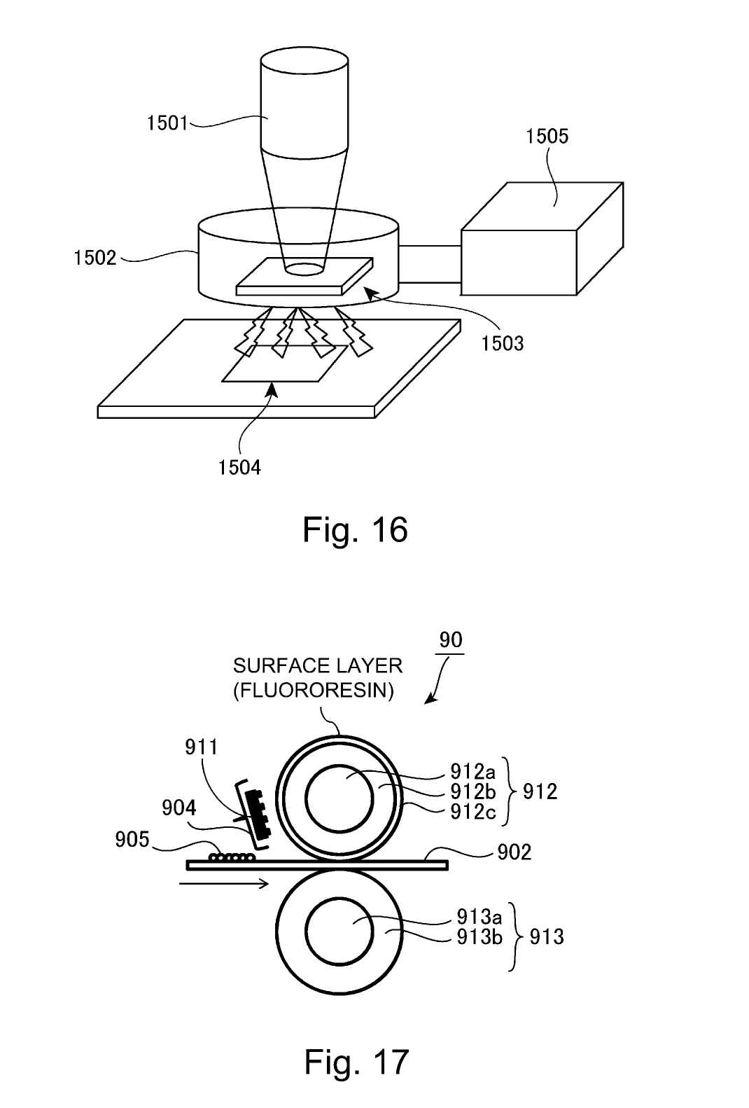

As shown in FIG. 10, even when the uneven portion of the minute structure is formed in the same manner, compared with other high-melting point metal materials, titanium is capable of radiating the infrared rays having the wavelength of 3.4 μm with high efficiency. For that reason, a heating element was actually prototyped using titanium and then a fixing performance of the toner image was evaluated. Specifically, as shown in FIG. 14, the heating element was prototyped by forming the uneven portion of the minute structure on a silicon substrate and then by coating the uneven portion with titanium in a thin layer. As shown in FIG. 16, the prototyped heating element was placed in an evacuated transparent container and then was heated by energization. Thereafter, paper as the recording material was irradiated with the infrared rays through the transparent container, and then the fixing performance of the respective color toners was evaluated.

### (Manufacturing Method of Heating Element)

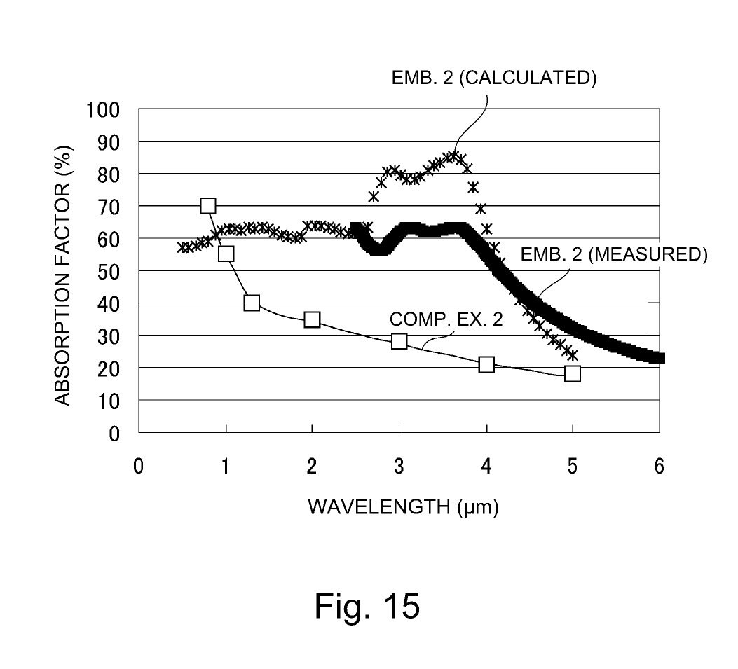

In FIG. 14, (a) and (b) are electron micrographs of a surface structure of the heating element, in which (a) is a perspective view, and (b) is a sectional view. FIG. 15 is an illustration of an infrared radiation wavelength characteristic of other prototyped heating element.

The heating element was prototyped in the following manner.

(1) A resist layer was formed on the surface of the silicon substrate, and then was partly removed by photolithography, so that a mask layer was formed in a lattice (grid) pattern.

(2) The silicon substrate on which the mask layer was formed was subjected to dry etching, so that the minute structure having a periodical uneven portion was formed three-dimensionally in the lattice pattern on one of surfaces of the silicon substrate, so that the heating element was prepared. The thus-formed three-dimensional lattice has a size of 3.4 μm in depth and 1.7 μm in inside dimension of each lattice with respect to each of length and width direction. The uneven portion can be prepared deeply with respect to a vertical direction (depth direction), and therefore reactive ion etching (so-called DEEP-PIE) method was used.

(3) Formation of a metal film in which titanium is laminated in layers by sputtering on the surface of the substrate of the heating element having the surface minute structure was effected, so that the surface of the minute structure on the silicon substrate was coated with the titanium layer in a thickness of about 100 nm. The reason why titanium is selected is that the infrared radiation peak can be generated with high efficiency at a position in the neighborhood of the infrared absorption peak wavelength of 3.4 μm of the methylene group as shown in FIG. 10.

(4) The infrared absorption characteristic of the prototyped heating element was measured by an FT-IR spectrometer (“Spectrum One”, manufactured by Perkin Elmer Inc.).

As shown in FIG. 15, the infrared absorption characteristic (indicated by x (mark)) of the heating element in Embodiment 2 was obtained by theoretical calculation, and then was compared with the infrared absorption characteristic (actually minute structured) of the prototyped heating element in Embodiment 2. These heating elements were prepared in the same condition. As a result, the wavelength range in which the peak of the infrared absorption characteristic was generated was substantially the same between results of the theoretical calculation and the actual measurement of the prototyped heating element.

### (Evaluation of Fixing Performance of Heating Element)

FIG. 16 is an illustration of a fixing device in which the prototyped heating element was mounted. As shown in FIG. 16, the fixing device was prototyped and then a prototyped heating element 1503 was mounted in the fixing device, and thereafter the fixing performance of a toner image 1504 on paper (recording material) was evaluated in the following manner. The recessed portions of the heating element 1503 was formed of titanium as an example of the metal having the melting point of 1600° C. or more at least on the surface thereof.

(1) The heating element 1503 was placed in a vacuum container 1503 of barium fluoride in a state in which the surface thereof where the minute structure was formed was directed downwardly. In order to prevent oxidation of the heating element 1503, the vacuum container 1502 was evacuated by a vacuum pump 1505.

(2) The infrared rays were focused on the back surface of the heating element 1503 from an outside of the vacuum container 1502 by using a halogen lamp 1501 (1000 W, available from Ushio Inc.), and then the temperature of the heating element 1503 was increased up to about 1000° C. An upper-limit temperature for heating was set at 1000° C. under constraints of the structures and the materials for the vacuum container 1502 and the heating element 1503.

(3) Below the vacuum container 1502, plain paper (recording material) on which the toner image 1504 formed with the black toner and the yellow toner was carried was inserted, and after a lapse of 10 seconds, the fixing property of the toner image was evaluated. Evaluation items of the fixing property are glossiness of the fixed image and the presence or absence of blister through eye observation.

(4) Then, the prototyped heating element 1503 in Embodiment 2 shown in FIG. 16 was replaced with a heating element in Comparison Example 2 in which a silicon substrate having no uneven portion of the minute structure was coated with the titanium layer, and thereafter was subjected to the same evaluation as in Embodiment 2. The heating element 1503 in Embodiment 2 and the heating element in Comparison Example 2 were evaluated with respect to the following evaluation items by “o” and “x”.

TABLE 1

| | | | | |
|---|---|---|---|---|
| Toner | BT*¹ | BT*¹ | YT*² | YT*² |
| Item | GL*³ | BL*⁴ | GL*³ | BL*⁴ |
| EMB. 2 | ∘ | ∘ | ∘ | ∘ |
| COMP. EX. 2 | x | x | ∘ | ∘ |

*¹“BT” is the black toner.
*²“YT” is the yellow toner.
*³“GL” is the glossiness.
*⁴“BL” is the blister.

As shown in Table 1, compared with the flat-plate heating element in Comparison Example 2, the heating element 1503 in Embodiment 2 in which the minute structure is formed on the surface thereof suppresses generation of a difference in glossiness and a blister of an image caused due to the difference in melting state of the toner image 1504. Compared with the flat-plate heating element in Comparison Example 2, the heating element 1503 in Embodiment 2 in which the minute structure is formed on the surface thereof has a small difference in melting state between the yellow toner image and the black toner image.

### Embodiment 3

In Embodiments 1 and 2, the toner image is heated in a non-contact manner and is fixed on the recording material by using a relationship between the infrared absorption beak wavelength and the CH bond (methylene group) as the functional group contained in the molecules of the polymer material constituting the member-to-be-heated such as the toner or the recording material. This is because the CH bond (methylene group) is a representative functional group constituting the resin material contained in the toner.

However, the infrared absorption beak wavelength usable for heating the toner image is not limited to that of the OH bond (methylene group). Other than the CH bond (representative absorption wavelength: 3.4 μm), it is also possible to use OH group (representative absorption wavelength: 2.8 μm), NH bond (representative absorption wavelength: 3.0 μm), CF bond (representative absorption wavelength: 8.3 μm and 8.7 μm), and the like. Accordingly, the infrared absorption wavelength range resulting from the bond or the functional group contained in the polymer constituting the toner is roughly 2.6 μm or more and 3.6 μm or less. Therefore, it is desirable that a wavelength position showing maximum intensity of the light, for the heating, with which the toner image or the recording material is irradiated is 2.6 μm or more and 3.6 μm or less.

### (Heating by OH Group)

In Embodiment 3, an example of a fixing device for heating not only the toner image but also paper as the recording material by using the infrared absorption by the OH group (representative absorption wavelength: 2.8 μm) will be described. Further, also in the case where the OH group is contained in the material for the heating belt or the material for the feeding belt which are other than the recording material and the toner, the present invention is similarly applicable in that the same minute structure is formed and used for heating the toner image and for fixing the toner image onto the recording material.

As shown in FIG. 4, in the case where the resin material for the toner has the OH group in addition to the CH bond as the functional group, heating of the toner image by the heating element in which the between wavelength of the radiation infrared rays is set at the wavelength of 2.6 μm-3.2 μm as the infrared absorption peak wavelength of the OH group is particularly effective. Particularly, in the case where the functional group of the molecules of the polymer material contained in the toner principally contains the OH group, such toner image heating is effective. When the infrared rays selectively heat the OH group, it is preferable that also the recording material is heated together with the toner image since the paper as the recording material on which the toner image is transferred sufficiently contains the OH group in the molecular structure thereof.

The infrared absorption peak of the CH group is 2.6 μm-3.2 μm when a hydrogen bond type and a free-radical type are combined. For this reason, in the case where the OH group is heated selectively, as the representative length of the uneven portion of the minute structure on the surface of the heating element 901H shown in FIG. 3, there is a need to set a representative uneven portion diameter of 1.3 μm or more and 1.6 μm or less. This is because, as described in Embodiment 1, the infrared rays having a wavelength of 2.6 μm or more and 3.2 μm or less which is twice the representative uneven portion diameter of 1.3 μm or more and 1.6 μm are preferentially radiated. The method of preparing the uneven portion of the minute structure is as described above in Embodiments 1 and 2.

The manner of determining the representative length of the minute structure uneven portion and the standard deviation are the same as those described above in (Structure of heating element) in Embodiment 1, and therefore the center of the absorption wavelength of the CH bond may only be required to be changed to the center of the absorption wavelength of the OH group.

Also with respect to the proportion in the minute structure uneven portion, the formula (1) is similarly applicable. All of the electromagnetic wave generated from the recessed portions each having the representative length L is absorbed by the medium having the OH group, and therefore when the recessed portion having the representative length L exists in the amount of 70% or more, the difference in a manner of melting of the member-to-be-heated and heating non-uniformity are not generated. That is, of the large number of minute structures, 70% or more of the minute structures may only be required to fall within the range of the representative length L.

As shown in FIG. 1, a lamp heater 901 in Embodiment 3 is mounted in the fixing device 90 of the image forming apparatus 100. As shown in FIG. 3, the lamp heater 901 is prepared by incorporating the heating element 901H, which is formed in a lamp shape and which has the surface where the minute structure is formed, into the transparent tube 901G having the high infrared transmission efficiency. The inside of the transparent tube 901G evacuated or filled with the inert gas in order to prevent the oxidation of the heating element 901H. The infrared absorption peak wavelength of the OH group is 2.8 μm at the center thereof, and therefore the transparent tube 901G may be formed of quartz glass, but may desirably be a material which has transparency to the farther infrared rays.

As a method of using the infrared absorption by the CH group, it is desirable that a method in which the toner image is placed on the recording material during heating and is heated-fixed on the recording material is used. This is because the recording material represented by paper is constituted by cellulose, and the polymer of the cellulose contains the large number of OH groups and thus the infrared rays having the center wavelength of 2.8 μm which are not completely absorbed by the toner image are absorbed also by the recording material, so that the OH groups contribute to the increase in temperature at the boundary between the toner and the recording material.

Further, in many cases, the polymer material contains various molecular structures. In these cases, the CH bond and the OH group exist in mixture, and therefore the absorption wavelength range is 2.6 μm-3.6 μm. In this case, similarly as in Embodiment 1, a maximum of radiation intensity of the heating element may only be required to be 2.6 μm-3.6 μm.

### Effect of Embodiment 3

As described above, in Embodiment 3, the recording material which is formed of the material having the hydroxyl group (OH group) and on which the toner image is carried is irradiated with the infrared rays, so that at least the recording material is heated. On the surface of the heating element 901H, the large number of recessed portions each having the opening length corresponding to ½ of the infrared absorption peak wavelength of the hydroxyl group are formed and disposed closely. Each of the recessed portions has a unit structure having a depth corresponding to the integral multiple of the infrared absorption peak wavelength of the hydroxyl group with respect to the depth direction.

In the case where the recording material is paper, the cellulose molecules of the paper contain the large number of OH groups, so that the paper as the recording material can be effectively heated by the infrared rays passed through the toner image, and therefore heating efficiency of the fixing device 90 is suitably increased.

Further, the heating element 901H has an infrared radiation characteristic such that the absorption band of the OH group contained in the respective color toners in common can be effectively heated, and therefore the yellow toner image and the black toner image can be substantially equally heated. For this reason, even when a particular infrared absorbent is added to the toners, the yellow toner image and the black toner image are heated substantially equally, so that the difference in glossiness of the fixed image can be eliminated. As a result, compared with Embodiment 1, the infrared rays can be effectively used, so that consumption power of the heating element 901E can be saved.

Further, the infrared energy emitted from the heating element 901H has already been focused into a particular wavelength range, and therefore compared with a constitution in which the general-purpose heating source is combined with an optical filter, inputted energy can be effectively radiated, so that the energy can be saved.

In Embodiment 3, the toner and the paper are representatively described as the member-to-be-heated, but a similar power saving effect can be realized even in the case where the recording material, other than the paper, containing the resin material rich in OH group or the feeding belt for feeding the recording material is designed as the member-to-be-heated.

### Modified Embodiment 6

In the case where the polymer material contains amino group, also the infrared rays having the wavelength range of 2.7 μm-3.1 μm which is the infrared absorption wavelength range of the amino group. in Embodiment 3, also the infrared absorption by the amino group contributes to the toner image heating similarly as in the case of the infrared absorption by the OH group.

### Embodiment 4

FIG. 17 is an illustration of a structure of a fixing device in this embodiment. As shown in FIG. 17, a fixing device 90 is mounted, in place of the fixing device 90 in Embodiment 1, in the image forming apparatus 100 shown in FIG. 1.

The fixing device 90 in this embodiment is of a heat-pressing type in which the toner image is heated in contact with the toner image carrying surface of the recording material 902. The fixing device 90 sandwiches and feeds the recording material 902 carrying thereon the toner image 905 in a nip between a fixing roller 912 and a pressing roller 913, so that the image is fixed on the recording material. The surface layer of the fixing roller 912 contains a polymer material rich in fluoromethylene group.

The pressing roller 913 is prepared by forming a silicone rubber elastic layer 913b on the surface of a stainless steel base material 913a. The fixing roller 912 is prepared by forming a silicone rubber elastic layer 912b on the surface of a stainless steel base material 912a and then by coating the surface of the elastic layer 912b with a parting layer (surface layer) 912c. The parting layer 912c contains, as a main component, polytetrafluoroethylene (PTFE) as an example of the fluorinated resin material, and therefore is rich in fluoromethylene group.

The heating element 911 is disposed oppositely to the parting layer 912c of the fixing roller 912, and a reflecting mirror 904 is disposed in a back side of the heating element 911. The reflecting mirror 904 is disposed for causing the infrared rays dissipated from the back surface of the heating element 911 to enter the heating element 911.

On the surface, of the heating element 911, opposing the parting layer 912c, the minute structure providing the infrared radiation peak wavelength, corresponding to the infrared absorption peak wavelength resulting from the CF bond is formed. On the surface of the heating element 911, a large number of recessed portions each having the opening length corresponding to ½ of the infrared absorption peak wavelength resulting from the CF fixing roller are formed and disposed closely. Each recessed portion has a unit structure having a depth corresponding to the integral multiple of the infrared absorption peak wavelength resulting from the CF bond with respect to the depth direction.

### (Heating by CF Bond)

The surface layer of the fixing roller 912 is formed in general of the fluoro-resin material such as PTFE or PFA. In the case of the fluoro-resin material, the CF bond forms a characteristic absorption wavelength range. In the case of the CF bond, as described above, the wavelength peak is 8.3 μm and 8.7 μm. Accordingly, the infrared absorption wavelength range resulting from the bond or the functional group contained in the polymer constituting the fixing member surface is 8.2 μm or more and 8.8 μm or less. Therefore, it is preferable that an infrared heat generating device in which an emission peak of the light for the heating is 8.2 μm or more and 8.8 μm or less is used.

The representative length of the heating element (radiation element) in this case is 4.15 μm and 4.35 μm similarly as in the case of the CH bond described above. By taking into consideration the preparation accuracy of the heating element and the error in absorption wavelength similarly as in the case of the CH bond, the representative length of the uneven portion of the heating element is 4.1 μm-4.4 μm. For this reason, the unit structure inside dimension of the periodical uneven lattice structure of the infrared heat generating device may preferably be 4.1 μm or more and 4.4 μm or less.

The manner of determining the representative length of the minute structure uneven portion and the standard deviation are the same as those described above in (Structure of heating element) in Embodiment 1, and therefore the center of the absorption wavelength of the CH bond may only be required to be changed to the center of the absorption wavelength of the CF bond. For that reason, on the surface of the infrared generating portion, the large number of recessed portions each having the opening length corresponding to 4.1 μm-4.4 μm which corresponds to the infrared absorption peak wavelength resulting from the CF bond are formed and disposed closely.

Also with respect to the proportion in the minute structure uneven portion, the formula (1) is similarly applicable. All of the electromagnetic wave generated from the recessed portions each having the representative length L is absorbed by the medium having the CF bond, and therefore when the recessed portion having the representative length L exists in the amount of 70% or more, the heat generation of the surface layer material is sufficiently ensured. That is, of the large number of minute structures, 70% or more of the minute structures may only be required to fall within the range of the representative length L.

### (Number of CF Bonds Necessary for Heating)

A necessary minimum number of the CH bonds in the fluoro-resin material for obtaining the fixed image by sufficiently heating the fixing roller 912 can be obtained as follows. From the above equation [III], the energy E per photon at the representative wavelength λ=3.4 μm of the infrared rays is obtained from the Planck's law by the following equation.

E=hC/λ=6.6×10⁻³⁴×3×10⁸/(8.5×10⁻⁶)=2.33×10⁻²⁰ (J/particle)

When absorbance ABS of the representative fluoro-resin (thickness: 2.5 μm) at the wavelength of 8.5 μm is measured, the following equation is obtained.

ABS=4.0

As described in a reference book (Shigenao Maruyama, “Light Energy Engineering”, Yokendo Co., Ltd., 2004, p. 225), the absorbance ABS at the wavelength λ=8.5 μm can be converted into light absorptivity a at the wavelength λ=8.5 μm by using Lambert-Beer's law.

α=1-1/eps (ABS)=0.98 [IV]

Therefore, 98% of energy per photon is absorbed by the CF bond.

On the other hand, with respect to the layer of 50 mm in diameter, 330 mm in length and 25 μm in thickness, the amount of the fluoro-resin is 0.88 g, and the specific heat c of the toner is about 1.0 J/g/K, and therefore the energy Q required to increase the temperature of the entire fluoro-resin by average ΔT=150° C. is represented by the following equation.

Q=mcΔT=0.88×1.0×150=132 (J)

Further, 98% of the energy per photon is absorbed by the CF bond, and therefore the number NCF of the CF bonds required to increase the entire fluoro-resin by ΔT=150° C. is represented by the following equation.

NCF=132/(2.33×10⁻²⁰×0.98)=5.8×10²¹ (particles)=0.96×10⁻³ (mol)

Accordingly, it is preferable that the bond or functional group which shows the absorption peak at the wavelength of 8.5 μm in the infrared range is contained in an amount of 0.96×10⁻³ (mol) or more in the surface layer of the fixing member. Assuming that a basic skeleton of the fluoro-resin is constituted by the CF₂, the molecular weight of CF₂ is 50, and therefore the number of CF₂ groups contained in 0.8 g of the fluoro-resin material is represented by the following formula.

0.88/50=0.0176=17.6×10⁻³ (mol)

Therefore, from 0.96/17.6=0.0545, when about 5.4% of the CF bond is contained, the fixing member can be sufficiently increased in temperature. For convenience, in this embodiment, as the functional group having the infrared absorption peak wavelength of 8.5 μm, the CF bond is used, but the number of another bond (group) other than the CF bond, having the infrared absorption peak wavelength of 8.5 μm is contained in the number of the functional group obtained in the above-described calculation.

### Effect of Embodiment 4

As described above, in Embodiment 4, it becomes possible to efficiently heat only the fluoro-resin in the surface layer of the heating element 911 from the outside of the fixing roller 912. At this time, the temperature is not so increased at a portion constituted by a material (or member) other than the toner and the fluoro-resin material for the fixing roller 912. Further, also when the recording material 902 is wound about the fixing roller 912, the recording material 902 does not contain the CF bond in general, and therefore is not increased in temperature, thus being convenient. Further, the fixing roller 912 can be heated immediately in front of the nip where the toner is to be thermally melted, and therefore the fixing roller 912 can be efficiently heated, so that a time required for increasing the surface temperature of the fixing roller 912 to a predetermined temperature can be shortened.

### Other Embodiments

Embodiments 1 to 4 to which the present invention is applicable were specifically described above, but a part or all of constitutions in First to Fourth Embodiments can be replaced with alternative constitutions thereof within the scope of the concept of the present invention.

Accordingly, with respect to dimensions, materials, shapes, relative arrangements of constituent elements described in First and to Fourth Embodiments, the scope of the present invention is not intended to be limited thereto unless otherwise particularly specified.

For example, the heating element 901H of the lamp heater 901 shown in FIG. 3 may also be provided with the energization heating layer independently of the infrared radiation member on which the closely disposed uneven minute structures are formed. The lamp heater 901 shown in FIG. 3 may also be prepared by forming and arranging a plurality of linear filaments, in parallel, each having the minute structure on the entire surface thereof and then by incorporating the filaments in the tube having the transparency to the infrared rays.

The means for heating the infrared radiation member is not limited to energization. The energization may also be replaced with electromagnetic induction heating (IH), nichrome wire heating, the halogen lamp, the ceramic heater or the like. In Embodiment 1, the toner is described as the member-to-be-heated, but the recording material containing the resin material or feeding belt having the CH₂ group may also be used as the member-to-be-heated. In Embodiment 4, the heating of the fixing roller is described, but in the same constitution, the fixing belt may also be heated.

The present invention is applicable to not only a fixing device in which the roller member or the belt member is contacted to the (unfixed) toner image to thermally deform the toner thereby to fix the toner image, but also an image heating apparatus for heating a partly fixed image or a fixed image.

The image forming apparatus can be carried out irrespective of one drum type/tandem type. The image forming apparatus can also be carried out irrespective of the number of the photosensitive members, a charging type, a type of formation of the electrostatic latent image, a transfer type, a fixing type, and the like. In the above-described embodiments, only a principal portion relating to formation/transfer of the toner image was described, but by adding necessary devices, equipment and casing structures and the like, the present invention can be carried out in image forming apparatuses of various uses, such as printers, various printing machines, copying machines, facsimile machines, and multi-function machines.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 044644/2014 filed Mar. 7, 2014, which is hereby incorporated by reference.

1-14. (canceled)

15. An image forming apparatus comprising:
an image forming portion configured to form a toner image on a recording material;
a rotatable fixing member configured to fix the toner image formed on the recording material by said image forming portion; and
a light irradiating portion configured to irradiate said rotatable fixing member with light,
wherein said rotatable fixing member has a surface layer including a resin material containing a functional group, and
wherein an infrared absorption wavelength range resulting from the functional group is 8.2 μm or more and 8.8 μm or less, and a maximum intensity wavelength of the light with which the toner image is irradiated by said light irradiating portion is in arrange of 8.2 μm or more and 8.8 μm or less.

16. An image forming apparatus according to claim 15, wherein the functional group is CF bond.

17. An image forming apparatus according to claim 15, wherein said resin material contains the functional group in an amount of 0.96×10⁻³ mol.

18. An image forming apparatus according to claim 15, wherein said light irradiating portion has a structure in which recessed portions are arranged in a lattice shape.

19. An image forming apparatus according to claim 18, wherein the functional group is CF bond, and an inside dimension of each of the recessed portions is 4.1 μm or more and 4.4 μm or less.
